(19) United States
(12) Patent Application Publication
(10) Pub. No.: US 2018/0196611 A1
(43) Pub. Date: Jul. 12, 2018

(54) HIGHLY SCALABLE COMPUTATIONAL ACTIVE SSD STORAGE DEVICE

(71) Applicant: AGENCY FOR SCIENCE, TECHNOLOGY AND RESEARCH, Singapore (SG)

(72) Inventors: Qingsong WEI, Singapore (SG); Cheng CHEN, Singapore (SG); Khal Leong YONG, Singapore (SG); Pantelis Sophoclis ALEXOPOULOS, Singapore (SG)

(21) Appl. No.: 15/741,235

(22) PCT Filed: Sep. 8, 2016
(86) PCT No.: PCT/SG2016/050439

§ 371 Date: Dec. 29, 2017

(30) Foreign Application Priority Data
Sep. 8, 2015 (SG) 10201507185V

(51) Int. Cl. G06F 3/06

(52) U.S. Cl. CPC G06F 3/0613; G06F 3/0688; G06F 3/0659; G06F 3/0658

(57) ABSTRACT

The present application relates to a computational active Solid-State Drive(SSD) storage device, comprising: an active interface configured for data communication with one or more host machines, the active interface being configured to at least receive one or more instructions from the one or more host machines; a CPU connected with the active interface; and non-volatile memory (NVM), wherein the NVM is configured to store metadata for utilisation by the CPU to handle the one or more instructions received from the one or more host machines.

### FIELD OF THE INVENTION

The present invention relates to active solid-state drive (SSD).

### BACKGROUND

Solid state drives (SSDs) have shown a great potential to change storage infrastructure fundamentally through their high performance and low power consumption as compared to current HDD-based storage infrastructure. The SSDs have different internal structures from hard disks, and are widely being deployed in servers and data centres by virtue of their high performance and low power consumption. However, in many of the current technologies, the SSDs merely deploy flash memory board SSDs as a faster block storage device, resulting in limited communication between a host system and SSDs. Further, the SSD's internal Flash Translation Layer (FTL), Garbage Collection (GC) and Wear Levelling (WL) work independently which result in lowering achievable efficiency. Consequently, SSD's internal resources are not fully utilized. There are large data movement requirements between SSDs and host machines.

On the other hand, hardware resource inside the SSDs including CPU and bandwidth handling devices continue to increase. High parallelism exists inside the SSDs via multiple channels of flash memories. However, internal bandwidth of SSDs currently uses at about 50% or lower maximum bandwidth capability. In the meanwhile, internal FTL and GC also consume bandwidth of the SSDs.

Thus, what is needed is a highly scalable computational active SSD storage device which is configured to arrange and execute data placement and computational tasks at the SSD and closer to data, instead of at the host machines, so that the resource utilization, overall performance and lifetime of SSD can be potentially increased. Furthermore, other desirable features and characteristics will become apparent from the subsequent detailed description and the appended claims, taken in conjunction with the accompanying drawings and this background of the disclosure.

### SUMMARY OF THE INVENTION

In accordance with a first aspect, the present disclosure provides a computational active Solid-State Drive (SSD) storage device. The computational active Solid-State Drive(SSD) storage device comprises an active interface configured for data communication with one or more host machines, the active interface being configured to at least receive one or more instructions from the one or more host machines; a CPU connected with the active interface; and non-volatile memory (NVM), wherein the NVM is configured to store metadata for utilisation by the CPU to handle the one or more instructions received from the one or more host machines.

In accordance with a second aspect, the present disclosure provides a method of data placement in a computational active SSD storage device, the computational active SSD storage device comprising an active interface configured for data communication with one or more host machines, the active interface being configured to at least receive one or more instructions from the one or more host machines; a CPU connected with the active interface; and non-volatile memory (NVM), wherein the NVM is configured to store metadata for utilisation by the CPU to handle the one or more instructions received from the one or more host machines. The method comprises steps of receiving one or more instructions from the one or more host machines; retrieving metadata stored in the NVM at least in response to the one or more instructions; and in response of the one or more instructions, locating data within one or more flash memories via a corresponding one of a plurality of flash memory controllers in the SSD based on the metadata retrieved from the NVM.

In accordance with a third aspect, the present disclosure provides a host-server system employing at least a computational active Solid-State Drive(SSD) storage device, wherein the computational active SSD storage device at least comprises an active interface configured for data communication with one or more host machines, the active interface being configured to at least receive one or more instructions from the one or more host machines; a CPU connected with the active interface and non-volatile memory (NVM), wherein the NVM is configured to store metadata for utilisation by the CPU to handle the one or more instructions received from the one or more host machines.

### BRIEF DESCRIPTION OF THE DRAWINGS

Example embodiments of the invention will be better understood and readily apparent to one of ordinary skill in the art from the following written description, by way of example only, and in conjunction with the drawings. The drawings are not necessarily to scale, emphasis instead generally being placed upon illustrating the principles of the invention, in which:

FIG. 1A shows a block diagram of hardware architecture of a computational active SSD in accordance with an embodiment.

FIG. 1B shows a block diagram of software architecture of the computational active SSD in accordance with the embodiment.

FIG. 2 shows a schematic block diagram of the hardware architecture of FIG. 1A in accordance with the embodiment of the computational active SSD.

FIG. 3 shows a block diagram of a host-server system employing the embodiment of the computational active SSD of FIG. 2 depicting a first data placement method.

FIG. 4 shows a block diagram of a host-server system employing the embodiment of the computational active SSD of FIG. 2 depicting a second data placement method.

FIG. 5 shows a diagram of metadata handling in the embodiment of the computational active SSD in accordance with the second data placement method of FIG. 4.

Skilled artisans will appreciate that elements in the figures are illustrated for simplicity and clarity and have not necessarily been depicted to scale. For example, the dimensions of some of the elements in the schematic diagram may be exaggerated in respect to other elements to help to improve understanding of the present embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

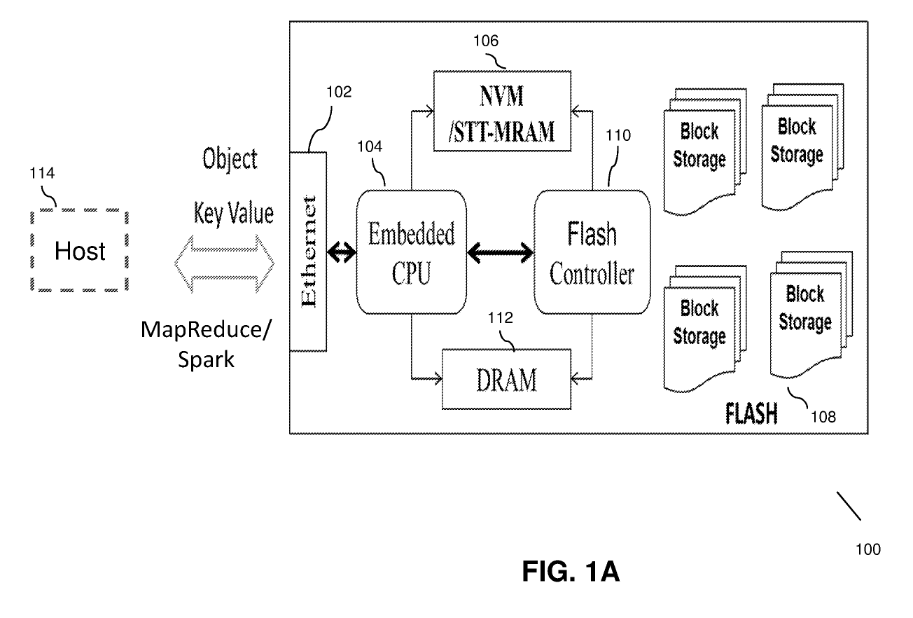

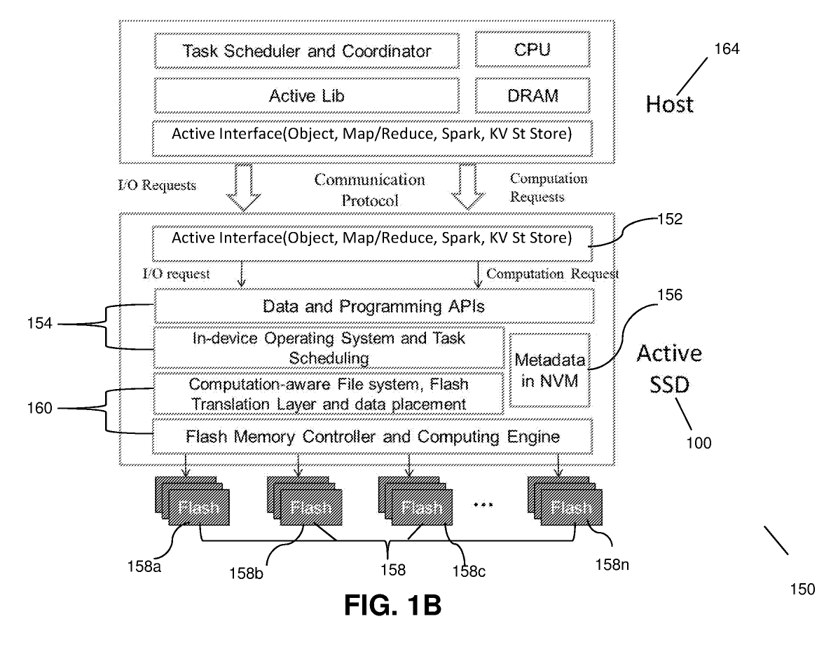

FIG. 1A refers to a block diagram of hardware architecture of a computational active SSD storage device 100 (interchangeably referred to as computational active SSD 100 in the present application) in accordance with an embodiment. As shown in FIG. 1A, the computational active SSD 100 comprises an active interface 102 configured for data communication with one or more host machines 114. The active interface 102 can be configured to communicate data of one or more of types. The one or more types of data comprise object data, file data, key value (KV) data and similar data known by a skilled person in the art. In the present embodiment, the active interface 102 is configured to at least receive one or more instructions from the one or more host machines 114. The one or more instructions can be selected from a group comprising I/O requests, object/file command/requests, Map/Reduce command/requests, Spark data analysis task, KV Store command/requests or similar commands/requests familiar to the skilled person in the art. These commands/requests may involve data-intensive computing activities of a computational nature and referred to as computational tasks in the present disclosure. The computational active SSD 100 further comprises a CPU 104 connected to the active interface 102. The CPU 104 may be a multi-core CPU 104.

The computational active SSD 100 further comprises non-volatile memory (NVM) 106 including Spin-transfer torque magnetic random-access memory (STT-MRAM), Phase Change Memory(PCM), Resistive Random access Memory(RRAM) or 3DXpoint, etc. 106. The NVM 106 is connected to the CPU 104 and is configured to store metadata for utilisation by the CPU 104 to handle the one or more instructions received from the one or more host machines 114. In the information era, metadata is known as “data that provides information about other data”. Metadata summarizes basic information about data, which can make finding and working with particular instances of data easier. For example, author, date created, date modified and file size are examples of very basic document metadata. Having the ability to filter through that metadata will make it much easier for one to locate a specific document. In addition to document files, metadata is known to be used for images, videos, spreadsheets and web pages. For example, metadata for web pages contain descriptions of the page's contents, as well as keywords linked to the content. In the present application, the metadata stored in the NVM 106 can comprise data about data placement, e.g. allocation of instructions/tasks into any embedded storage device or location of any data stored in any embedded storage device (e.g. flash memory, which will be described in the following description) in the SSD 100, data about instructions received from any of the one or more host machines 114, data about mapping from object to flash pages, and/or intermediate data received from flash memory controllers (which will be described in the following description) that exercise data processing functionalities (e.g. executing computational tasks).

As shown in FIG. 1A, the computational active SSD 100 can further comprise a plurality of block storage devices 108. In the present embodiment, the plurality of block storage devices 108 comprise a plurality of flash memories 108. The plurality of flash memories 108 are connected to at least a flash memory controller 110 in the computational active SSD 100. The flash memory controller 110 can comprise a computing engine. The computing engine can be a processor embedded in the flash memory controller 110. In this manner, the flash memory controller 110 is capable of executing computing activities. The flash memory controller 110 is further coupled to a dynamic random access memory (DRAM) 112 that is in connection with the CPU 104. The flash memory controller 110 and the embedded CPU 104 can be configured to be in direct communication. Both the flash memory controller 110 and the embedded CPU 104 can communicate with the NVM 106 including STT-MRAM, RRAM, 3DXpoint, PCM, etc. 106 so that the NVM including STT-MRAM, RRAM, 3DXpoint, PCM, etc. 106 can collect, store and handle metadata of every instruction/task that the CPU 104 has received and/or allocated and/or that the flash memory controller 110 has executed.

FIG. 1B shows a block diagram of software architecture 150 of the computational active SSD 100 in accordance with the embodiment. The software architecture 150 comprises an active interface block 152 to implement the functions of the active interface 102 as described above for communication with the one or more host machine 164. As illustrated in FIG. 1B, the host machine 164 may comprise components such as CPU, DRAM, task scheduler and coordinator, active library that provides users/programmers with a programming interface to call active SSD functions at one or more active SSDs 100 interconnected in a host-server system, and active interface for communication with the one or more active SSDs 100. The task scheduler and coordinator function can be implemented within the CPU. For communication with the active SSD 100, the active interface in the host machine 164 supports communication protocol for communicating instructions such as I/O request, object/file command/request, Map/Reduce command/request, Spark data analysis task, KV Store command/request or similar commands/requests familiar to those skilled person in the art. As described above with regard to FIG. 1A, these instructions can comprise computational tasks (or “computation requests” as illustrated in FIG. 1B). These instructions, upon receipt at the active interface block 152, are transmitted to a CPU block 154 to implement the functions of the CPU 104 as described above.

In the embodiment of FIG. 1B, the CPU block 154 can comprise a sub-block to implement data and programming APIs for user-defined programming and a sub-block to implement an in-device operating system and task scheduling. The active SSD 100 further comprises a flash memory controller block 160. The flash memory controller block 160 can comprise a sub-block to implement the flash memory controller 110 with a computing engine. On top of the sub-block for flash memory controller 110, the flash memory controller block 160 can further comprise a sub-block to establish a file system and a flash translation layer (FTL). The file system is configured to keep track of how data is stored and retrieved on the plurality of flash memories. The file system can be a computation-aware file system. The sub-block implementing the flash memory controller 110 provides the computing engine for running the FTL and the file system. Alternatively, the FTL and the file system can be run by the CPU block 154.

In the embodiment of FIG. 1B, the active SSD 100 comprises a plurality of flash memories 158 which are grouped into one or more memory channels 158a, 158b, 158c . . . 158n. The one or more memory channels 158a, 158b, 158c . . . 158n are connected to the sub-block for implementing the flash memory controller 110 with a computing engine. This sub-block can comprise one or more flash memory controllers 110. Each of the one or more flash memory controllers 110 can be connected to one of the one or more memory channels 158a, 158b, 158c . . . 158n.

The CPU block 154 and the flash memory controller block 160 are configured to communicate with a NVM block 156. The NVM block 156 has data stored therein, including metadata and file system journal. On top of the various types of metadata as described above with regard to FIG. 1A, the metadata can comprise data about the file system and the FTL. Therefore, the metadata can be utilised by the CPU block 154 to handle the instructions received from the one or more host machine 164. For example, at least in response to the received instructions, the in-device operating system and task scheduling sub-block of the CPU block 154 can retrieve the metadata stored in the NVM block 156. Based on data location information provided comprised in the metadata stored in the NVM block 156, the in-device operating system and task scheduling sub-block of the CPU block 154 can schedule and allocate the instructions to the respective memory channels. By utilising the metadata locally stored in the NVM block 156, the in-device operating system and task scheduling sub-block of the CPU block 154 can locate, read or write data into and out of the plurality of flash memories 158 via the corresponding one of the one or more flash memory controllers 110. In response to the allocated instructions, the flash memory controller block 160 can use the computing engine to arrange data placement amid the plurality of flash memories in the corresponding memory channel. The data placement can be decided in view of the metadata in the NVM block 156. The information of the data placement can be transferred back by the flash memory controller block 160 to the NVM block 156 to update portions of the metadata.

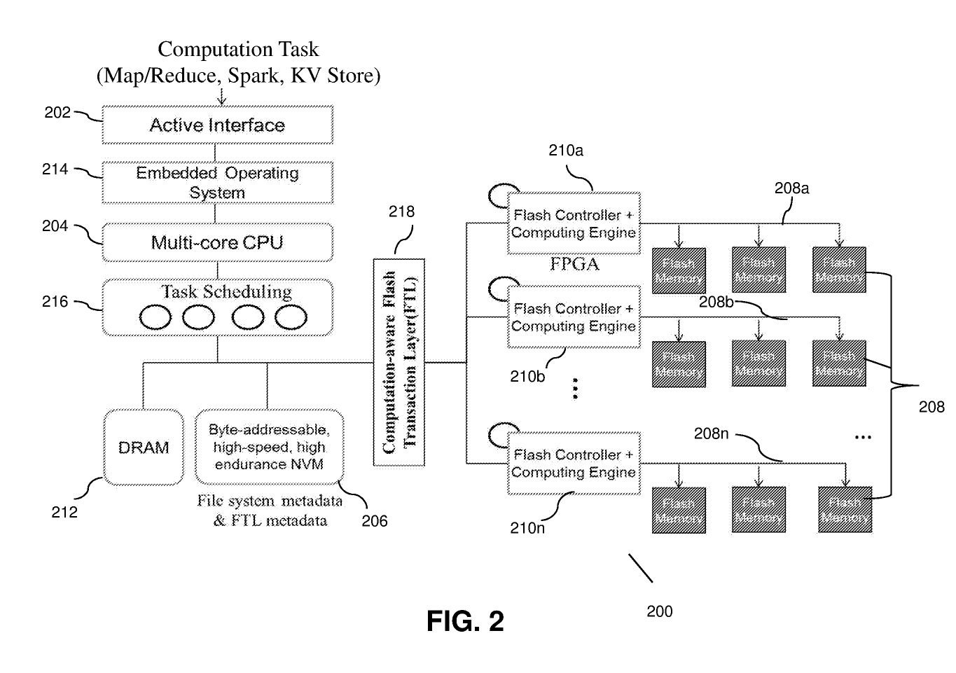

FIG. 2 shows a schematic block diagram 200 of the hardware architecture in accordance with the embodiment of the computational active SSD 100 as shown in FIG. 1A. As illustrated in FIG. 2, the hardware architecture 200 comprises an active interface 202 configured to at least receive one or more instructions from the host machine 114 (not shown in FIG. 2). The instructions can comprise computational tasks that involve data computing activities. As shown in FIG. 2, the computation tasks can be a Map/Reduce job, a Spark data analysis task, or a KV store job. The instructions received at the active interface 202 are then forwarded to a CPU 204. The CPU 204 can be a multi-core CPU 204 as illustrated in FIG. 2. The hardware architecture 200 comprises an embedded operating system connected to the CPU 204. As described above with regard to FIG. 1B, the embedded operating system 214 can be implemented in a portion of the CPU 204. The hardware architecture 200 further comprises a task scheduling module 216 connected to the CPU 204. The task scheduling module 216 can schedule an order of processing of the received instructions. The task scheduling module 216 can also be implemented in a portion of the CPU 204. The portion of the CPU 204 can be one or more cores of the multiple cores in the CPU 204. A DRAM 212 is connected to the CPU 204.

As illustrated in FIG. 2, the hardware architecture 200 further comprises NVM 206 connected to the CPU 204 and one or more flash memory controllers 210a, 210b . . . 210n. As shown in FIG. 2, each of the one or more flash memory controllers 210a, 210b . . . 210n can be implemented by a field-programmable gate array (FPGA) with a computing engine. The hardware architecture 200 further comprises a plurality of flash memories 208. The plurality of flash memories 208 can be clustered into one or more memory channels 208a, 208b . . . 208n, wherein the plurality of flash memories 108, 208 are distributed evenly in each channel 208a, 208b . . . 208n. Each of the one or more memory channels 208a, 208b . . . 208n is connected to one of the one or more flash memory controllers 210a, 210b . . . 210n. Since the flash memory controller is capable of computing, each of the one or more memory channels 208a, 208b . . . 208n forms an independent memory channel 208a, 208b . . . 208n that is capable of exercising computing activities (e.g. executing computational tasks).

As illustrated in FIG. 2, the hardware architecture 200 further comprises a Flash Translation Layer (FTL) 218 connected to the NVM 206 and the one or more flash memory controllers 210a, 210b . . . 210n. The FTL 218 can further comprise a portion for the file system as illustrated in FIG. 1B. The FTL 218 can be run by the CPU 204. Alternatively, the FTL 218 can be comprised in and run by the one or more flash memory controllers 210a, 210b . . . 210n. The FTL 218 can be a computation-aware FTL 218. The NVM 206 can be a byte-addressable NVM, a high-speed NVM and/or a high endurance NVM. The NVM 206 stores data, including various types of metadata as described above with regard to FIGS. 1A and 1B. The metadata can comprise data about the file system and the FTL 218. The metadata stored in the NVM 206 is used by the CPU 204 to handle the one or more instructions received from the one or more host machines 114. In an embodiment, the metadata can be retrieved by the CPU 204 to locate, read or write data into or out of the plurality of flash memories 208 via the corresponding one or more flash memory controllers 210a, 210b . . . 210n. The retrieval of the metadata can be initiated by the CPU 204 in response to receiving instructions from the one or more host machines 114. Additionally, the retrieval of the metadata by the CPU 204 can be initiated during internal file management to optimise the file system and the FTL of the active SSD 100. The CPU 204 can assign the one or more instructions to the respective memory channels 208a, 208b . . . 208n based on the metadata retrieved from the NVM 206.

In the present embodiment, if the one or more instructions comprise one or more computational tasks in relation to the data stored in the respective flash memory, the corresponding flash memory controller 210a, 210b . . . 210n of the respective memory channels 208a, 208b . . . 208n assigned with the one or more computational tasks can retrieve the data from the respective flash memory based on the metadata and execute the computational tasks with the retrieved data locally in the active SSD. Each of the corresponding flash memory controllers 210a, 210b . . . 210n of the one or more memory channels 208a, 208b . . . 208n can then forward an intermediate output to the NVM 206. The intermediate output collected at the NVM 206 will be sent to the CPU 204 to be finalized and forwarded back to the one or more host machines 114.

Accordingly, the utilisation of the metadata locally stored in the NVM 206 advantageously contributes to parallelized local data retrieval and computing achieved in the present application and thus reduces data movement, as conventionally required, from the active SSD to the host machine 114.

Furthermore, aside from connecting with the CPU 204, the NVM 206 is also connected to the one or more flash memory controllers 210a, 210b . . . 210n via the FTL 218 as arranged in the hardware architecture 200. In this manner, the metadata stored in the NVM 206 about the file system and the data stored in the plurality of flash memories is accessible by the FTL 218, Wear Levelling (WL, not shown) and/or Garbage Collection (GC, not shown). Likewise, the information of the FTL 218, WL and/or GC can be stored into the NVM 206 as metadata which can be used by the file system so as to optimize the FTL 218 organization and reduce updates of the FTL 218. Therefore, the metadata locally stored in the NVM 206 further contributes to improve the performance of the file system in the present application.

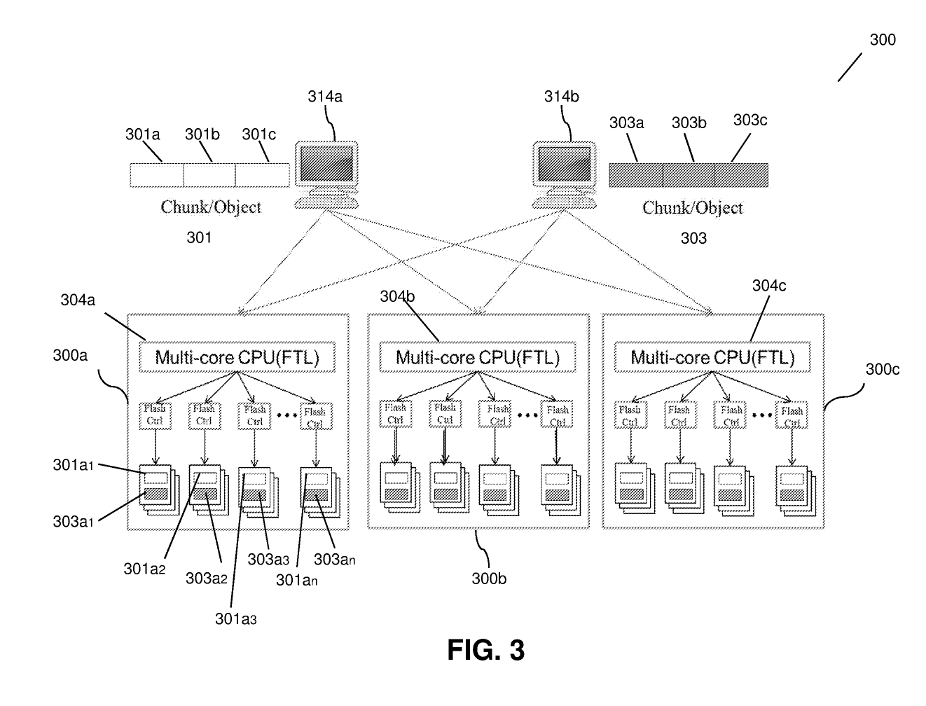

The one or more instructions received from the one or more host machines 114 comprise data. FIG. 3 shows a block diagram depicting a first data placement method in a host-server system 300 employing the embodiment of the computational active SSD of FIG. 2.

As shown in FIG. 3, the host-server system 300 can comprise two host machines 301, 303. In the embodiment shown in FIG. 3, each of the host machines 314a, 314b sending a distributed server system with an instruction 301, 303. For example, the instruction 301, 303 can be a request to store an Object file 301, 303. The distributed server system comprises a plurality of computational active SSDs as described above and illustrated in FIG. 2. As shown in FIG. 3, the present distributed server system comprises three computational active SSDs 300a, 300b . . . 300c.

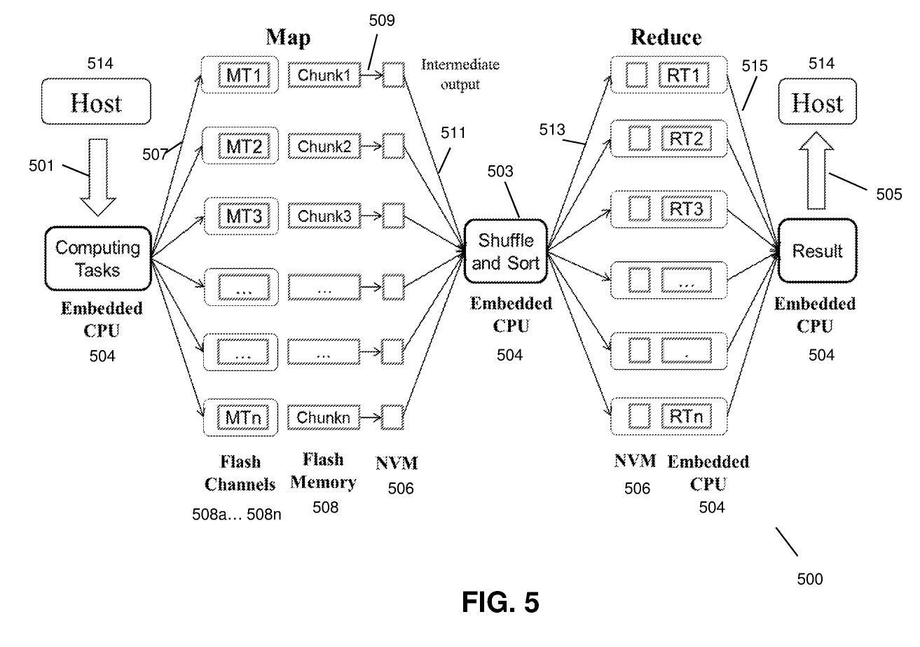

As illustrated in FIG. 3, the host machines 314a, 314b divide the instructions 301, 303 into chunks 301a, 301b, 301c, 303a, 303b, 303c. Each chunk can be up to 64 to 128 MB, depending on application workload as required by the instructions 301, 303. In FIG. 3, chunks 301a, 301b, 301c, 303a, 303b, 303c are assigned across all of the active SSDs 300a, 300b . . . 300c in the distributed server system. As shown in FIG. 3, the chunks 301a, 301b, 301c, 303a, 303b, 303c is distributed evenly into each of the active SSDs 300a, 300b . . . 300c in the distributed server system. The person skilled in the art is readily to understand that these chunks can be assigned unevenly across the distributed server system based on the current capacity of each active SSD 300a, 300b . . . 300c as recorded in the metadata stored in the NVM (not illustrated in FIG. 3) of each active SSD 300a, 300b . . . 300c. This is because in the present application, each CPU 304a, 304b, 304c in the active SSD 300a, 300b . . . 300c can communicate the metadata with the host machines 314a, 314b during or after every instruction cycle. The handling of the metadata will be further described in the following description corresponding to FIG. 5.

Upon receipt in the active SSDs 330a, 300b . . . 300c, each chunk 301a, 301b, 301c, 303a, 303b, 303c is further striped by the embedded CPU 304a, 304b and 304c, and stored across all flash memory channels via corresponding flash memory controllers. For example, if the instruction 301, 303 involves data-intensive computation, then the chunk 301a, 303a assigned to the active SSD 300a can be computing task 301a, 303a. The computing task 301a, 303a is divided by the embedded CPU 304a into subtasks 301ₐ₁, 301ₐ₂, 301ₐ₃ . . . 301ₐₙ; 303ₐ₁, 303ₐ₂, 303ₐ₃ . . . 303ₐₙ and assigned to all flash memory channels.

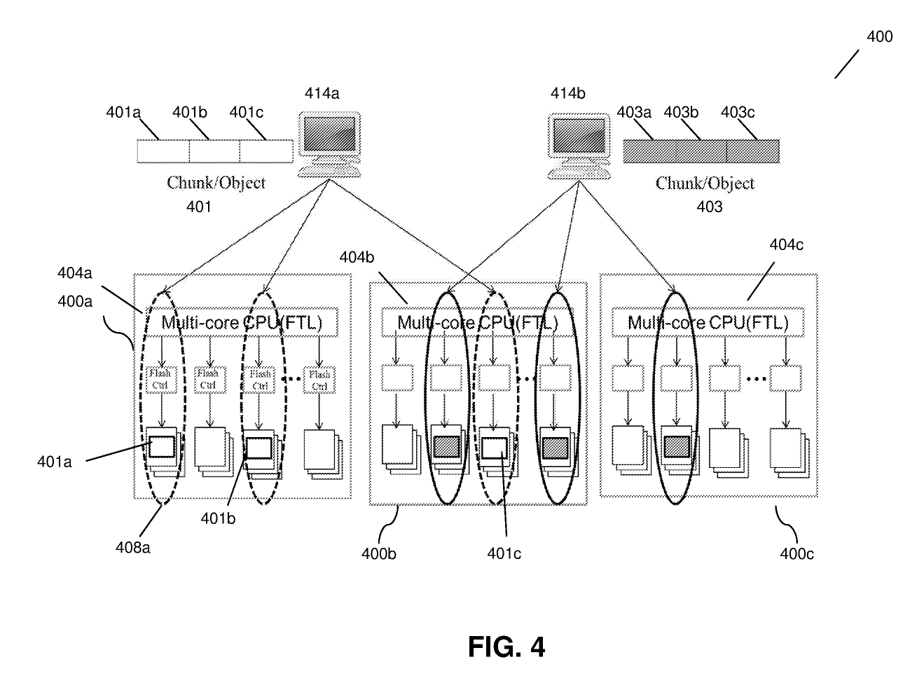

Similarly, FIG. 4 shows a block diagram depicting a second data placement method in a host-server system 400 employing the embodiment of the computational active SSD of FIG. 2.

The host-server system 400 can comprise two host machines 301, 303. In the embodiment shown in FIG. 4, each of the host machines 414a, 414b sends an instruction 401, 403 to a distributed server system. The instruction 401, 403 can be a request to store an Object file 401, 403. As shown in FIG. 4, the present distributed server system can comprise three computational active SSDs 400a, 400b . . . 400c.

As illustrated in FIG. 4, the host machines 414a, 414b divide the instructions 401, 403 into chunks 401a, 401b, 401c, 403a, 403b, 403c. Each chunk can be up to 64 to 128 MB, depending on application workload as required by the instructions 401, 403. In FIG. 4, chunks 401a, 401b, 401c, 403a, 403b, 403c are assigned across all of the active SSDs 400a, 400b . . . 400c in the distributed server system. In the embodiment shown in FIG. 4, the assignment/distribution of the chunks is based on the current capacity of each active SSD 400a, 400b . . . 400c rendered in the metadata stored in the NVM (not shown in FIG. 4) handled by respective CPU 404a, 404b, 404c in the active SSDs 400a, 400b . . . 400c. The handling of the metadata will be further described in the following description corresponding to FIG. 5.

Inside the active SSDs 400a, 400b . . . 400c where the chunks are assigned, the CPU 404a, 404b, 404c assigns each chunk to a flash memory channel via corresponding flash memory controller. For example, in the second data placement method shown in FIG. 4, the chunks 401a, 401b, 401c from the host machine 414a are only assigned to the two active SSD 400a, 400b in the distributed server system. Two chunks 401a, 401b are assigned to the active SSD 400a; the other chunk 401c is assigned to the active SSD 400b, Upon receipt of these two chunks 401a, 401b, the CPU 404a of the active SSD 400a assigns them into two flash memory channels via corresponding flash memory controllers. If the three chunks 401a, 401b, 401c are computing tasks, the two computing tasks 401a, 401b can be conducted at the corresponding flash memory controllers parallely in the active SSD 400a. Furthermore, the three chunks 401a, 401b, 401c are conducted parallely at the corresponding flash memory controllers of the active SSDs 400a, 400b in the distributed server system. Likewise, the data placement of the chunks 403a, 403b, 403c will be similarly arranged in the active SSDs of the distributed server system.

FIG. 5 shows a diagram 500 of metadata handling in the embodiment of the computational active SSD in accordance with the second data placement method of FIG. 4. The skilled person in the art is readily to understand that the metadata handling can also be applied in the first data placement method shown in FIG. 3.

The diagram 500 exemplifies an embodiment of metadata handling at the active SSD 100, 200, 400a, 400b, 400c where a Map/Reduce instruction is assigned 501 by a host machine 514. The Map/Reduce instruction can involve computation on data stored in the flash memories of the active SSD. Upon receipt of the Map/Reduce instruction, the CPU 504 of the active SSD retrieves (this step is not shown in FIG. 5) metadata from NVM 506 of the active SSD to locate the data called for computation by the Map/Reduce instruction. In the present embodiment, the data is stored as chunks in a plurality of flash memories across one or more flash memory channels 508a . . . 508n. Based on the metadata, the CPU 504 divides the Map/Reduce instruction input sub-instructions and assigns 507 the sub-instructions to the one or more flash memory channels 508a . . . 508n via corresponding flash memory controllers. Based on the metadata, the chunks of data stored in the plurality of flash memories are retrieved/read for computation. The sub-instructions are processed as Map tasks with the corresponding chunk of data stored in the one or more flash memory channels 508a . . . 508n in a parallel manner at the corresponding flash memory controllers.

The processed chunks, as intermediate outputs of the Map tasks, are stored in the flash memories in the one or more flash memory channels 508a . . . 508n. The intermediate outputs are then transferred 509 from the corresponding flash memory controllers to the NVM 506. The metadata of the data called for by the Map/Reduce instruction is then updated in the NVM corresponding to the processed Map tasks.

The CPU 504 then communicates with the NVM to retrieve 511 the intermediate outputs and the updated metadata about the chunks of the data called for by the Map/Reduce instruction stored therein. The intermediate outputs of the Maps tasks will then shuffled and sorted 503 by the CPU 504. The sorted intermediate outputs will then, become inputs of Reduce tasks to be processed 513 at the CPU 504.

After the Reduce tasks are completed, the CPU 504 will then update at least portions of the metadata of the data called for by the Map/Reduce instruction in the NVM 506 corresponding to the completed Reduce tasks. The outputs of the Reduce tasks will be aggregated 515 by the CPU 504 to arrive at a result of the Map/Reduce instruction. The active SSD then transmits 505 the result of the Map/Reduce instruction to the host machine 514. As described above, the communication between the active SSD and the host machine 514 are via active interfaces as described above.

In this manner, the metadata stored in the NVM 506 is utilised by the CPU 504 to locate, read and write data into and out of the plurality of flash memories via corresponding one of the one or more flash memory controllers. As the metadata of the relevant data, which may be called for by the instructions, is stored locally in the NVM 506, the CPU 504 can distribute instructions to the respective memory channel based on the metadata. Thus, if the distributed instructions comprise computational tasks, which involves data computing activities, can be executed locally in the active SSD near the corresponding flash memory where the relevant data is stored. Additionally, the parallelism rendered by the one or more memory channels 508a, 508b . . . 508n is advantageously utilised for parallel data retrieval and computing. The utilisation of the parallelism in turn contributes to improve internal bandwidth within the active SSD.

In view of the above, various embodiment of the present application provide a highly scalable computational active SSD storage device which moves computation to the SSD and closer to data. The computational active SSD comprises a CPU and flash controllers such that the SSD can receive instructions, including computing tasks, assigned from host machines, and execute these computing tasks locally in the SSD near where the data involved is stored. Computing tasks can be executed in parallel in the flash memories in the computational active SSD to fully utilize the computation and bandwidth resource. Further, computation-aware File Translation Layer (FTL) is used to place data so that computation tasks can be assigned close to data. Furthermore, NVM is used in the computational active SSD to handle metadata of the computational active SSD so that file system and the FTL of the SSD can be optimized. In this manner, the file system and FTL of the SSD is co-designed to improve efficiency such that the present application is advantageously efficient in improving performance, reducing data movement between the SSD and host machines, reducing energy consumption, and increasing resource utilization.

It will be appreciated by a person skilled in the art that numerous variations and/or modifications may be made to the present invention as shown in the embodiments without departing from a spirit or scope of the invention as broadly described. The embodiments are, therefore, to be considered in all respects to be illustrative and not restrictive.

1. A computational active Solid-State Drive(SSD) storage device, comprising:
an active interface configured for data communication with one or more host machines, the active interface being configured to at least receive one or more instructions from the one or more host machines;
a CPU connected with the active interface;
a plurality of flash memories;
one or more flash memory controllers, wherein each of the one or more flash memory controllers is connected to one or more of the plurality of flash memories; and
non-volatile memory (NVM), wherein the NVM is configured to store metadata for utilisation by the CPU to handle the one or more instructions received from the one or more host machines,
wherein the metadata is utilised by the CPU to locate, read and write data into and out of the plurality of flash memories via corresponding one of the one or more flash memory controllers, and wherein the one or more flash memory controllers are configured to arrange data placement in the plurality of flash memories at least in response to the one or more instructions.

2. (canceled)

3. The computational active SSD storage device in accordance with claim 1, wherein the one or more flash memory controllers are configured to update portions of the metadata at the NVM corresponding to the data placement.

4. The computational active SSD storage device in accordance with claim 1, wherein the NVM is a high endurance NVM.

5. The computational active SSD storage device in accordance with claim 1, wherein the NVM is a byte-addressable NVM.

6. The computational active SSD storage device in accordance with claim 1, wherein the active interface is configured to communicate data of one or more of types.

7. The computational active SSD storage device in accordance with claim 6, wherein the one or more of types comprise object data, file data and key value (KV) data.

8. The computational active SSD storage device in accordance with claim 1, wherein the one or more instructions comprise sub-instructions being divided by either the one or more host machines or the CPU.

9. The computational active SSD storage device in accordance with claim 8, wherein the one or more of the plurality of flash memories is configured to form one or more memory channels, each memory channel connecting to one of the one or more of flash memory controllers, and wherein the CPU is configured to distribute the sub-instructions to all of the one or more memory channels.

10. The computational active SSD storage device in accordance with claim 8, wherein the one or more of the plurality of flash memories is configured to form one or more memory channels, each memory channel connecting to one of the one or more of flash memory controllers, and wherein the CPU is configured to distribute the sub-instructions to a memory channel of the one or more memory channels.

11. The computational active SSD storage device in accordance with claim 1, further comprising:
a task scheduling module in communication with the CPU and the one or more flash memory controllers, wherein the task scheduling module is configured to schedule an order of processing of the one or more instructions.

12. The computational active SSD storage device in accordance with claim 1, wherein the CPU comprises multiple cores.

13. A method of data placement in a computational active SSD storage device, the computational active SSD storage device comprising:
an active interface configured for data communication with one or more host machines, the active interface being configured to at least receive one or more instructions from the one or more host machines;
a CPU connected with the active interface;
one or more flash memories;
a plurality of flash memory controllers, wherein each of the plurality of flash memory controllers is connected to one or more of the one or more flash memories; and
non-volatile memory (NVM), wherein the NVM is configured to store metadata for utilisation by the CPU to handle the one or more instructions received from the one or more host machines,
the method comprising:
receiving one or more instructions from the one or more host machines;
retrieving metadata stored in the NVM at least in response to the one or more instructions; and
in response of the one or more instructions, locating, reading and writing data into and out of the one or more flash memories via a corresponding one of a plurality of flash memory controllers in the SSD based on the metadata retrieved from the NVM, wherein the plurality of flash memory controllers are configured to arrange data placement in the one or more flash memories at least in response to the one or more instructions.

14. The method in accordance with claim 13, further comprising:
distributing the one or more instructions into at least one of the plurality of flash memory controllers, wherein each of the plurality of flash memory controllers forms a flash memory channel that is connected to at least one of the one or more flash memories.

15. The method in accordance with claim 14, wherein the distribution further comprises:
dividing the one or more instructions into a plurality of sub-instructions at the CPU, and
distributing the plurality of sub-instructions into all of the plurality of flash memory controllers in the SSD.

16. The method in accordance with claim 14, wherein the distribution further comprises:
wherein the one or more instructions comprise a plurality of sub-instructions divided at the one or more host machines.

17. The method in accordance with claim 14, wherein the locating of data comprises reading the data from the one or more flash memories via the corresponding one of the plurality of flash memory controllers, wherein the method further comprises:
updating portions of the metadata corresponding to the data read; and
storing the updated metadata into the NVM.

18. The method in accordance with claim 14, further comprising:
in response to the one or more instructions, writing data into the one or more flash memories via corresponding one of the plurality of flash memory controllers;
updating portions of the metadata corresponding to the data written; and
storing the updated metadata into the NVM.

19. The method in accordance with claim 17, further comprising:
receiving the updated portions of the metadata from the NVM;
shuffling and sorting the updated portions of the metadata; and
transmitting the sorted updated metadata to the one or more host machine.

20. A host-server system employing at least a computational active Solid-State Drive (SSD) storage device, wherein the computational active SSD storage device at least comprises:
an active interface configured for data communication with one or more host machines, the active interface being configured to at least receive one or more instructions from the one or more host machines;
a CPU connected with the active interface;
a plurality of flash memories;
one or more flash memory controllers wherein each of the one or more flash memory controllers is connected to one or more of the plurality of flash memories; and
non-volatile memory (NVM), wherein the NVM is configured to store metadata for utilisation by the CPU to handle the one or more instructions received from the one or more host machines,
wherein the metadata is utilised by the CPU to locate, read and write data into and out of the plurality of flash memories via corresponding one of the one or more flash memory controllers, and wherein the one or more flash memory controllers are configured to arrange data placement in the pluarlity of flash memories at least in response to the one or more instructions.
